(19) United States
(12) Patent Application Publication
(10) Pub. No.: US 2004/0156776 A1
(43) Pub. Date: Aug. 12, 2004

(54) Singlet oxygen oxidation of organic substrates

(76) Inventors: Walther Jary, Steinbach a. Attersee (AT); Peter Pochlauer, Linz (AT); Heinz Falk, Linz (AT); Thorsten Ganglberger, Linz (AT)

Correspondence Address: WENDEROTH, LIND & PONACK, L.L.P., 2033 K STREET N. W., SUITE 800, WASHINGTON, DC, 20006-1021, US

(21) Appl. No.: 10/775,157

(22) Filed: Feb. 11, 2004

(30) Foreign Application Priority Data
Feb. 12, 2003 (AT) A 205/2003

(51) Int. Cl. C01B 13/02

(52) U.S. Cl. 423/579

(57) ABSTRACT

Process for generating ¹O₂ in which an Sn(II) salt of the formula

SnXₙ (I)

in which X is an anion from the group consisting of trifluoromethanesulfonate, acetate, formate, oxalate, lactate, malonate, malate, tartrate, citrate, orthophosphate, sulfate, chloride, perchlorate and n is 1 or 2, is treated in an organic solvent at a temperature of from −80° C. to 20° C. with 1 to 2 mol of ozone per mole of tin compound, and the ¹O₂ which forms is used directly for the oxidation of organic substrates which react with ¹O₂.

The only singlet oxygen oxidation (¹O₂-Ox) which is currently carried out industrially is the photochemical ¹O₂-Ox in which the ¹O₂ is generated by a photochemical route. The disadvantage of this process is the high cost of the photochemical equipment required, and also a limited service life. The lamps required degenerate relatively rapidly during the oxidation as a result of the glass surface becoming dirty. In addition, this process is not suitable for colored substrates. The process is actually suitable only for fine chemicals which are produced on a relatively small scale. (La Chimica e I'Industria, 1982, Vol. 64, page 156)

For this reason, attempts have been made to find other process variants for the ¹O₂-Ox which are suitable for the ¹O₂-Ox of non-water-soluble, hydrophobic organic substrates.

J. Am. Chem. Soc., 1968, 90, 975 describes, for example, the classical “dark” ¹O₂-Ox in which ¹O₂ is generated not photochemically, but chemically. In this process, hydrophobic substrates are oxidized by means of a hypochlorite/H₂O₂ system in a solvent mixture of water and organic solvent. However, this process has found only a few synthetic applications since many substrates are only sparingly soluble in the required medium. Furthermore, the potential use is somewhat limited due to secondary reactions between hypochlorite and substrate or solvent. Furthermore, a large part of the ¹O₂ is deactivated in the gas phase. In addition, this process is not suitable for the industrial scale since attachment of the hypochlorite onto H₂O₂ is brought about in the organic medium, and a large excess of H₂O₂ is required to suppress the secondary reaction of substrate with hypochlorite. An additional disadvantage arises as a result of the formation of stoichiometric amounts of salt.

One variant of the “dark” ¹O₂-Ox which is not based on hypochlorite and thus should partly avoid the above disadvantages is known, for example, from J. Org. Chem., 1989, 54, 726 or J. Mol. Cat., 1997, 117, 439, according to which some water-soluble organic substrates are oxidized with H₂O₂ and a molybdate catalyst in water as solvent. According to Membrane Lipid Oxid. Vol. 11, 1991, 65, the ¹O₂-Ox of water-insoluble, organic substrates with the molybdate/H₂O₂ system is difficult since it was assumed that none of the customary solvents is suitable for maintaining the disproportionation, catalyzed by molybdate, of H₂O₂ into water and ¹O₂. The use of molybdenum catalysts, however, also has other disadvantages. For example, as well as catalyzing the H₂O₂ disproportionation, they also catalyze other undesired oxidations of some substrates. Allyl alcohols, for example, cannot be effectively peroxidized with the molybdate/H₂O₂ system since this substance group is epoxidized by molybdenum in the presence of H₂O₂. A further disadvantage of these catalysts is the relatively low pH range in which they function. These catalysts can only be used in the basic range between pH 9 and pH 12; the use of this system is accordingly unsuitable for acidic conditions.

A further way of chemically generating ¹O₂ is, for example, the heating of triphenyl phosphite ozonide, which is obtained from triphenyl phosphite and ozone. However, as is described, for example, in J. Org. Chem., Vol. 67, No 8, 2002, page 2418, this method is only used for mechanism studies since triphenyl phosphite is an expensive and also hazardous chemical.

During the base-catalyzed disproportionation of peracids, further reactive compounds are formed as well as ¹O₂, which lead to by-products.

Accordingly, it was an object of the present invention to find a way of generating ¹O₂ while avoiding the above disadvantages.

Unexpectedly, this object was achieved by the use of ozone and an Sn(II) compound.

Accordingly, the present invention provides a process for generating ¹O₂, which comprises treating an Sn(II) salt of the formula

SnXₙ (I)

in which X is an anion from the group consisting of trifluoromethanesulfonate, acetate, formate, oxalate, lactate, malonate, malate, tartrate, citrate, orthophosphate, sulfate, chloride, perchlorate and n is 1 or 2, in an organic solvent at a temperature of from −80° C. to 20° C. with 1 to 2 mol of ozone per mole of tin compound, and using the ¹O₂ which forms directly for the oxidation of organic substrates which react with ¹O₂.

In the process according to the invention, ¹O₂ is generated by the reaction of an Sn(II) salt of the formula (I) with ozone.

In the formula (1), X is an anion from the group consisting of trifluoromethaneulfonate, acetate, formate, oxalate, lactate, malonate, malate, tartrate, citrate, orthophosphate, sulfate, chloride, perchlorate and n is 1 or 2 depending on the anion.

Preferred Sn(II) salts are tin(II) trifluoromethanesulfonate or tin(II) acetate.

The Sn(II) salt is dissolved in an organic solvent. Suitable solvents are ethyl acetate, butyl acetate, methanol, ethanol, dichloromethane or acetic acid. Preference is given to using ethyl acetate.

The mixture is then cooled to −80° C. to 20° C., preferably to −80° C. to −5° C., and ozone is introduced.

Ozone is added in the process according to the invention in an amount of from 1 to 2.0 mol per mole of Sn(II) salt. Preference is given to using one equivalent of ozone.

The ¹O₂ which forms is then used for the oxidation of organic substrates which react with ¹O₂.

This may take place according to the invention by metering in a solution of the corresponding substrate during the reaction of the Sn(II) salt with ozone. The metering preferably takes place continuously in this case.

Suitable solvents for the substrate here are, in turn, ethyl acetate, butyl acetate, methanol, ethanol, dichloromethane or acetic acid.

Preference is given to using ethyl acetate.

Preference is given to using the solvent which is also used for dissolving the Sn(II) salt.

Where necessary, excess ozone is then blown out, for example by flushing with argon or nitrogen, and the reaction solution which remains, which comprises the oxidation product, is worked up.

However, the substrate solution may also be added only after the Sn(II) salt has reacted with ozone and any excess ozone has finally been removed.

If the reaction of the Sn(II) salt with ozone takes place at relatively low temperatures (e.g. −80° C.), then the reaction solution treated with the substrate solution can optionally be heated, for example to −10° C.

The reaction solution which comprises the oxidation product is worked up by customary methods, such as, for example, extraction, drying and isolation of the oxidation product, for example by column chromatography.

As organic substrates which react with ¹O₂ it is possible to use the following compounds: olefins which contain one or more, i.e. up to 10, preferably up to 6, particularly preferably up to 4, C═C double bonds; electron-rich aromatics, such as C₆-C₅₀, preferably up to C₃₀, particularly preferably up to C₂₀, phenols, polyalkylbenzenes, polyalkoxybenzenes; polycyclic aromatics having 2 to 10, preferably up to 6, particularly preferably up to 4, aromatic rings; sulfides, such as, for example, alkyl sulfides, alkenyl sulfides, aryl sulfides which are either mono- or disubstituted on the sulfur atom, and also heterocycles with an 0, N or S atom in the ring, such as, for example, C₄-C₅₀, preferably up to C₃₀, particularly preferably up to C₂₀, furans, C₄-C₅₀, preferably up to C₃₀, particularly preferably up to C₂₀, pyrroles, C₄-C₆₀, preferably up to C₃₀, particularly preferably up to C₂₀, thiophenes. The substrates can here have one or more substituents, such as halogen (F, Cl, Br, J), cyanide, carbonyl groups, hydroxyl groups, C₁-C₅₀, preferably up to C₃₀, particularly preferably up to C₂₀, alkoxy groups, C₁-C₅₀, preferably up to C₃₀, particularly preferably up to C₂₀, alkyl groups, C₆-C₅₀, preferably up to C₃₀, particularly preferably up to C₂₀, aryl groups, C₂-C₅₀, preferably up to C₃₀, particularly preferably up to C₂₀, alkenyl groups, C₂-C₅₀, preferably up to C₃₀, particularly preferably up to C₂₀, alkynyl groups, carboxylic acid groups, ester groups, amide groups, amino groups, nitro groups, silyl groups, silyloxy groups, sulfone groups, sulfoxide groups. In addition, the substrates may be substituted by one or more NR¹R² radicals in which R¹ or R² may be identical or different and are H; C₁-C₅₀, preferably up to C₃₀, particularly preferably up to C₂₀, alkyl; formyl; C₂-C₅₀, preferably up to C₃₀, particularly preferably up to C₂₀, acyl; C₇-C₅₀, preferably up to C₃₀, particularly preferably up to C₂₀, benzoyl, where R¹ and R² can also together form a ring, such as, for example, in a phthalimido group.

Examples of suitable substrates are: 2-butene; isobutene; 2-methyl-1-butene; 2-hexene; 1,3-butadiene; 2,3-dimethylbutene; Δ^{9,10}-octalin, 2-phthalimido-4-methyl-3-pentene; 2,3,-dimethyl-1,3-butadiene; 2,4-hexadiene; 2-chloro-4-methyl-3-pentene; 2-bromo-4-methyl-3-pentene; 1-trimethylsilylcyclohexene; 2,3-dimethyl-2-butenyl para-tolyl sulfone; 2,3-dimethyl-2-butenyl para-tolyl sulfoxide; N-cyclohexenyl-morpholine; 2-methyl-2-norbornene; terpinolene; α-pinene; β-pinene; β-citronellol; ocimene; citronellol; geraniol; farnesol; terpinene; limonene; trans-2,3-dimethylacrylic acid; α-terpinene; isoprene; cyclopentadiene; 1,4-diphenylbutadiene; 2-ethoxy-butadiene; 1,1′-dicyclohexenyl; cholesterol; ergosterol acetate; 5-chloro-1,3-cyclohexadiene; 3-methyl-2-buten-1-ol; 3,5,5-trimethylcyclohex-2-en-1-ol; phenol, 1,2,4-trimethoxybenzene, 2,3,6-trimethylphenol, 2,4,6-trimethylphenol, 1,4-dimethyl-naphthalene, furan, furfuryl alcohol, furfural, 2,5-dimethylfuran, isobenzofuran, dibenzyl sulfide, (2-methyl-5-tert-butyl)phenyl sulfide etc.

As a result of the oxidation according to the invention, the substrates produce the corresponding oxidation product. Alkenes, (polycyclic) aromatics or heteroaromatics give, in particular, hydroperoxides, peroxides, alcohols or ketones.

As a result of the process according to the invention, ¹O₂ is generated in a simple and efficient manner. A further advantage of the process is that no water is formed during the reaction.

### EXAMPLE 1

### Generation of Singlet Oxygen by Means of Ozone and Tin(II) trifluoromethanesulfonate at −80° C.

1.52 g (4.1 mmol) of tin(II) trifluoromethanesulfonate were dissolved in 150 ml of ethyl acetate and cooled to −80° C. in a batch ozonolysis apparatus. One equivalent of ozone was added to this solution at −80° C. Excess ozone was then blown off by flushing the apparatus with argon. The tin ozonoid complex generated in this way was treated with 0.25 g (1.8 mmol) of α-terpinene in 10 ml of ethyl acetate and the reaction solution was warmed to −10° C. This solution was filtered with suction over a frit containing celite into a vacuum flask filled with a sodium chloride/ice mixture.

This mixture was warmed to room temperature and the organic phase was separated from the aqueous phase. The aqueous phase was extracted again with ethyl acetate. The combined organic fractions were washed with water and then dried with sodium sulfate. Sodium sulfate was filtered off and the resulting solution was evaporated down under reduced pressure.

The singlet oxidation product (Ascaridol) was isolated from the resulting yellow oil by means of column chromatography. For this purpose, 10 g of silica gel 60A were used as the stationary phase, and a 9:1 mixture of n-hexane:MTBE was used as the mobile phase.

The combined fractions which comprised Ascaridol were evaporated down, giving a yellow oil. The product was characterized by means of ¹H-NMR and thin-layer chromatography.

Yield: 75 mg of Ascaridol (25% of theory).

### EXAMPLE 2-5

### Generation of Single Oxygen by Means of Ozone and Tin(II) Trifluoromethanesulfonate at −10° C.

1 equivalent of tin(II) trifluoromethanesulfonate based on the substrate used in each case was dissolved in 150 ml of ethyl acetate and cooled to −10° C. in a batch ozonolysis apparatus. One equivalent of ozone was added to this solution at −10° C. During the ozonolysis, the amount of substrate given in the table and dissolved in 10 ml of ethyl acetate was continuously metered into the reaction solution by means of a perfusor pump. Excess ozone was then blown out by flushing the apparatus with argon. This solution was filtered with suction over a frit containing celite into a vacuum flask filled with a sodium chloride/ice mixture.

This mixture was heated to room temperature and the organic phase was separated off from the aqueous phase. The aqueous phase was extracted again with ethyl acetate. The combined organic fractions were washed with water and then dried with sodium sulfate. Sodium sulfate was filtered off and the solution obtained was evaporated down under reduced pressure.

The product was characterized and quantified by means of ¹H-NMR, HPLC and thin-layer chromatography. The results are summarized in the table below.

| | | Amount | | | |
|---|---|---|---|---|---|
| | | used | Conver- | Yield | |
| Ex. No. | Substrate | [mg] | sion [%] | [%] | Product |
| 2 | 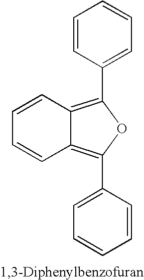 | 163 | 99.6 | 72.3 | 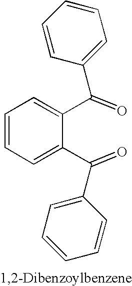 |
| 3 | 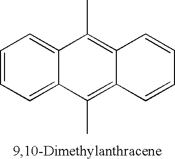 | 123.5 | 90.9 | 26.5 | 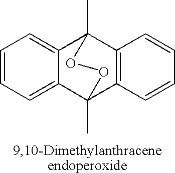 |
| 4 | 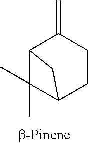 | 81.7 | 95.6 | 2.9 | 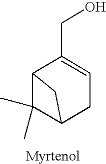 |
| 5 | 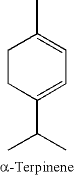 | 87.6 | 98.7 | 24.2\|5.2 | 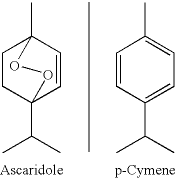 |

1. A process for generating 102 which comprises treating an Sn(II) salt of the formula
SnXₙ (I)
in which X is an anion from the group consisting of trifluoromethanesulfonate, acetate, formate, oxalate, lactate, malonate, malate, tartrate, citrate, orthophosphate, sulfate, chloride, perchlorate and n is 1 or 2, in an organic solvent at a temperature of from −80° C. to 20° C. with 1 to 2 mol of ozone per mole of tin compound, and using the ¹O₂ which forms directly for the oxidation of organic substrates which react with ¹O₂.

2. The process as claimed in claim 1, wherein the Sn(II) salt used is tin(II) trifluoromethanesulfonate or tin(II) acetate.

3. The process as claimed in claim 1, wherein the organic solvent used is ethyl acetate, butyl acetate, methanol, ethanol, dichloromethane or acetic acid.

4. The process as claimed in claim 1, wherein the reaction temperature is −80 to −5° C.

5. The process as claimed in claim 1, wherein one equivalent of ozone is used.

6. The process as claimed in claim 1, wherein a solution of an organic substrate which reacts with ¹O₂ is metered in during the reaction of the Sn(II) salt with ozone.

7. The process as claimed in claim 1, wherein a solution of an organic substrate which reacts with ¹O₂ is metered in after the reaction of the Sn(II) salt with ozone, following removal of any excess ozone.

8. The process as claimed in claim 6 or 7, wherein the solvent used for the substrate is ethyl acetate, butyl acetate, methanol, ethanol, dichloromethane or acetic acid.
